(19) United States
(12) Patent Application Publication
(10) Pub. No.: US 2012/0048985 A1
(43) Pub. Date: Mar. 1, 2012

(54) TEARING DEVICE OF A CONTINUOUS RIBBON OF PAPER MATERIAL TO BE SUPPLIED ON REWINDING MACHINES, REWINDING MACHINE FOR THE FORMATION OF LOGS OF PAPER EQUIPPED WITH SUCH A DEVICE AND TEARING METHOD OF A CONTINUOUS RIBBON OF PAPER MATERIAL ON REWINDING MACHINES

(75) Inventor: Giovanni GAMBINI, Pisa (IT)

(73) Assignee: GAMBINI INTERNATIONAL S.A., Luxembourg (LU)

(21) Appl. No.: 13/218,077

(22) Filed: Aug. 25, 2011

(30) Foreign Application Priority Data
Aug. 27, 2010 (IT) MI2010A 001579

(51) Int. Cl. B65H 35/10; B26F 3/02; B65H 19/26

(52) U.S. Cl. 242/521; 225/93

(57) ABSTRACT

The present invention concerns a tearing device of a continuous ribbon of paper material to be supplied on rewinding machines and a method for tearing the same ribbon. The device comprises mechanical tearing means to cause the tearing of the ribbon in correspondence of at least one perforation and weakening line of the same. The mechanical tearing means comprise an interception portion suitable for engaging, at least temporarily, the structure of the continuous ribbon, to cause it to break. The mechanical tearing means are mobile between a non operative position, in which the interception portion does not engage the ribbon, and an operative position, in which the interception portion engages the ribbon transversally until it causes it to break along a respective perforation and weakening line.

### CROSS-REFERENCE TO RELATED APPLICATIONS

This application claims the benefit of priority from Italian Patent Application No. MI2010A 001579 filed on Aug. 27, 2010, the contents of which are incorporated herein by reference.

### FIELD OF THE INVENTION

The present invention refers to a tearing device of a continuous ribbon of paper material to be supplied on rewinding machines.

The object of the present invention is also a rewinding machine for the formation of logs of paper equipped with the aforementioned tearing device.

The present invention also refers to a tearing method of a continuous ribbon of paper material on rewinding machines.

The object of the present invention is suitable for being used in the industrial field of machines and devices intended for making logs of paper, like for example toilet paper, kitchen roll and/or similar.

### BACKGROUND OF THE INVENTION

As known, the production of logs of paper is carried out by feeding a continuous ribbon of paper material along a predetermined path.

Generally, the continuous ribbon of paper material is taken through an incision station, at which a series of transversal perforation and structural weakening lines are made that make it easier to tear during its use.

Normally, the formation of transversal perforation and weakening lines requires that a series of openings or holes be made on the structure of the continuous ribbon, aligned along a direction perpendicular to the longitudinal development of the ribbon itself. The continuous ribbon coming out from the incision station thus has a series of transversal perforation and weakening lines parallel to one another and spaced according to regular intervals.

Once the aforementioned transversal perforation and weakening lines have been made, the continuous ribbon of paper material is led up to a joining or coupling station, at which a part of the continuous ribbon is glued onto a support core made from cardboard and having a tubular shape, provided on the outside with a predetermined quantity of glue.

Thereafter, the support core is set in rotation with the help of suitable winding rollers. The rotation of the support core causes the consequent winding of the continuous ribbon of paper material until the formation of the respective log of paper to be manufactured.

In order to avoid the unwinding of the continuous ribbon of paper material from the respective support core, it is necessary to glue its end part or sheet, through the so-called “end gluing” operation.

When a respective support core is wound with a predetermined number of sheets or layers of continuous ribbon of paper material, the latter must be cut to separate the last sheet of the log in formation from the first sheet of the next log to be formed.

The separation operation of the continuous ribbon of paper material is generally carried out through a tearing action that causes the breaking of the continuous ribbon along a respective transversal perforation and structural weakening line.

In accordance with a first known solution, the tearing action of the continuous ribbon can be carried out by varying the rotation speeds of the winding rollers so as to cause traction stress, in the desired point, sufficient to cause the breaking of the ribbon along the respective perforation and weakening line.

In accordance with a second known solution described and illustrated in document EP1618057, the tearing action of the continuous ribbon of paper material is carried out through high-pressure blowing of a respective fluid against the perforation and weakening line to be broken.

Although the aforementioned systems and methods for separating the continuous ribbon of paper material allow the desired breaking of the selected transversal perforation and weakening line, the Applicant has found that nevertheless they are not without drawbacks and can be improved in various aspects, mainly in relation to the structural simplicity of the devices and systems necessary for carrying out the tearing of the continuous ribbon, to the reduction of maintenance interventions, to the reduction of the costs of the components making up such devices and systems, as well as to the reduction of overall production and commercialisation costs of the logs of paper.

In particular, the Applicant has found that the known examples of devices and methods for carrying out the tearing of the aforementioned continuous ribbon of paper material are particularly complex and require continuous adjustments and corrections during the formation process of the logs of paper.

Of course, the continuous interventions to adjust the speeds of the winding rollers, as well as for example the blowing pressure of the tearing and separation fluid, interfere significantly with the formation process of the logs of paper.

It should also be considered that the complicated configuration of such devices and systems requires frequent and expensive maintenance interventions that end up increasing the overall production times and costs, also having a negative impact on the overall commercialisation costs of the aforementioned logs of paper.

### SUMMARY OF THE INVENTION

The main purpose of the present invention is to provide a tearing device of a continuous ribbon of paper material to be supplied on rewinding machines, a rewinding machine equipped with such a device and a tearing method of such a continuous ribbon, capable of solving the problems encountered in the prior art.

A further purpose of the present invention is to propose a tearing device and method that are simple.

Another purpose of the present invention is to reduce the overall number of maintenance interventions linked to the device or method for tearing the continuous ribbon of paper material.

A further purpose of the present invention is to reduce the overall production and commercialisation costs of logs of paper.

The purposes specified above and yet others are substantially accomplished by a tearing device of a continuous ribbon of paper material to be supplied on rewinding machines, a rewinding machine equipped with such a device and a method for tearing such a continuous ribbon, as expressed and described in the following claims.

It is provided, as an example, the description of a preferred but not exclusive embodiment of a tearing device of a continuous ribbon of paper material to be supplied on rewinding machines, a rewinding machine equipped with such a device and a method for tearing such a continuous ribbon, in accordance with the present invention.

### BRIEF DESCRIPTION OF THE DRAWINGS

Such a description will be made hereafter with reference to the attached drawings, provided just for indicating and therefore not limiting purposes, in which:

FIG. 1 is a schematic illustration of a tearing device of a continuous ribbon of paper material being fed on a rewinding machine, represented in a first significant condition and in accordance with the present invention;

FIG. 2 is a further schematic illustration of the device according to the previous figure, represented in a second significant condition;

FIG. 3 is a schematic representation, partially in section and partially in plan, of the device according to the previous figures.

### DETAILED DESCRIPTION OF THE INVENTION

With reference to the attached figures, reference numeral 1 wholly indicates a tearing device of a continuous ribbon of paper material being fed on a rewinding machine 2, in accordance with the present invention.

As can be seen in the attached figures, the tearing device 1, which will be illustrated in detail during the course of the present description, is operatively arranged on a rewinding machine 2 for the formation of logs 3 of paper, like for example toilet paper, kitchen roll and/or other types of paper materials.

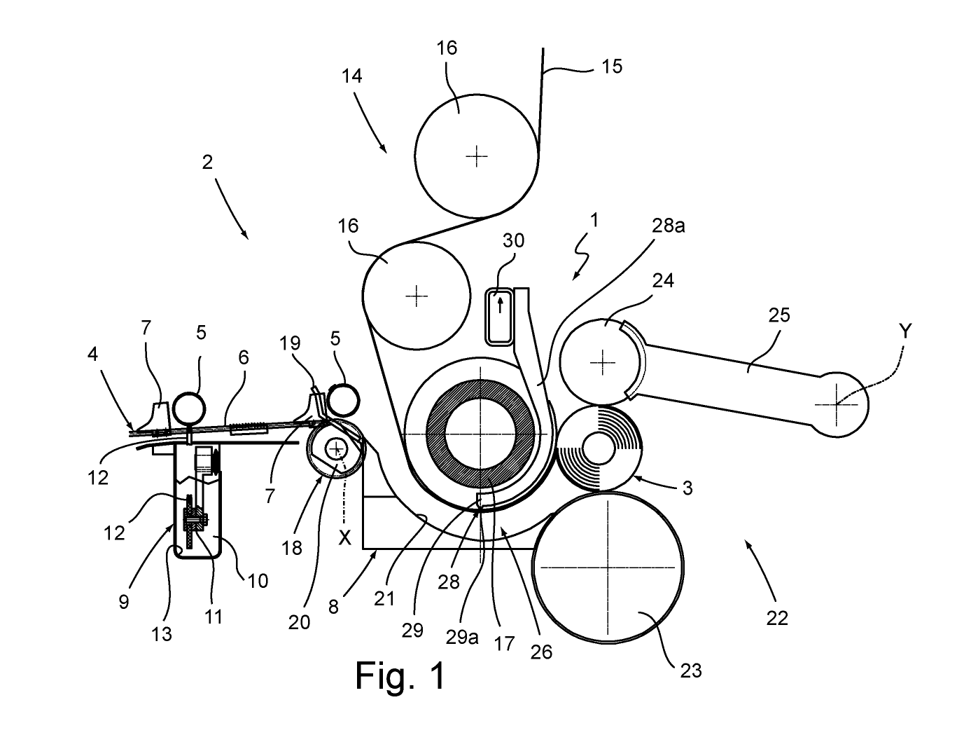

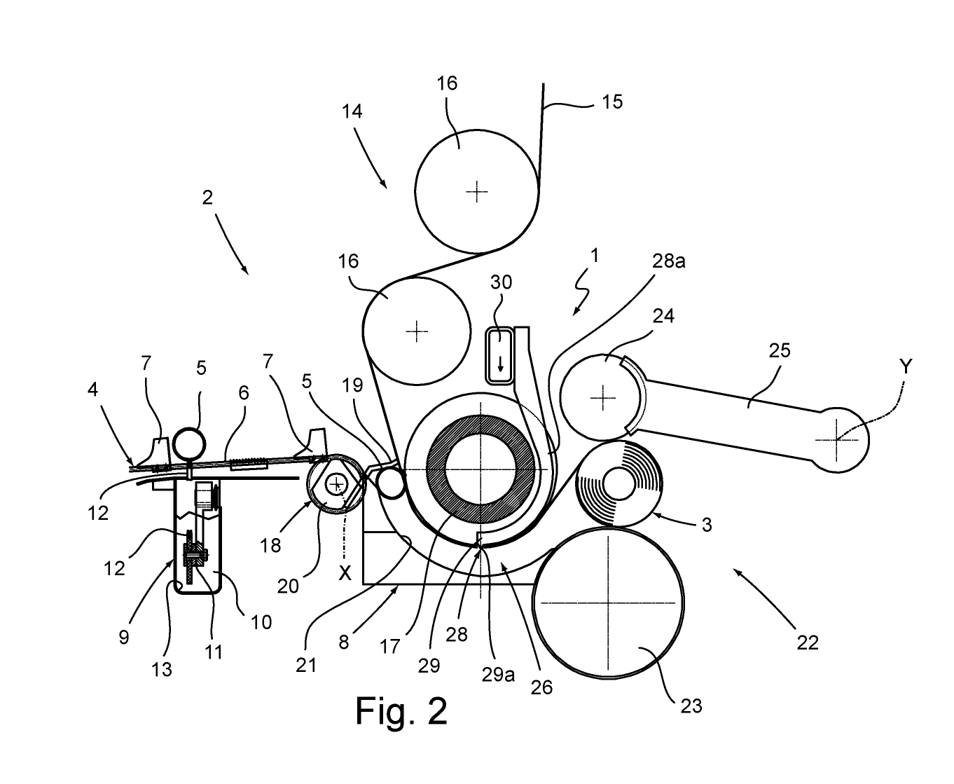

With reference to FIGS. 1 and 2, the aforementioned rewinding machine 2 comprises at least one supply station 4 of support cores 5, preferably made from cardboard, having a substantially cylindrical shape, in particular tubular.

As can be seen in FIGS. 1 and 2, the supply station of the support cores 5 is provided with an advancing plane 6 on which suitable abutment elements 7 operatively associated with the advancing plane 6 move the support cores 5 towards a joining and coupling station 8 of the machine 2.

At the supply station 4 of the support cores 5 and, in particular, along the advancing plane 6 of the latter, the machine 2 provides at least one application station 9 of a glue 10.

The application station 9 of the glue 10 is advantageously provided with a mechanical application device 11 that, through the alternate movement of an application blade 12, picks up a predetermined quantity of glue 10, dipping into a housing tank 13, to deposit it on the outer surface of the support core 5 rolling on the advancing plane 6.

Again with reference to FIGS. 1 and 2, the machine 2 has a supply station 14 of at least one continuous ribbon 15 of paper material that has a plurality of transversal spaced perforation and weakening lines according to regular intervals along the longitudinal development of the latter.

Generally, the transversal perforation and weakening lines of the continuous ribbons 3 of paper material are defined by a plurality of through openings aligned, with respect to one another, along a transversal direction, in particular substantially perpendicular, to the longitudinal development of such continuous ribbons 3.

The supply station 14 of the continuous ribbon 15 of paper material has one or more conveying and advancing rollers 16 that take the respective continuous ribbon 15 up to a roller 17 of the aforementioned joining and coupling station 8.

In detail, when the continuous ribbon 15 is at the aforementioned roller 17, it sticks to an outer portion thereof, with a respective engagement surface.

Again with reference to FIGS. 1 and 2, at the conveying station 8, the support cores 5 coming from the supply and application stations 4, 9 of the glue 10, and the continuous ribbon 15 of paper material coming from the supply station 14, converge to come into contact with each other. In this way, the continuous ribbon 15 of paper material present on the roller 17 adheres, at least partially, to the outer surface of a respective support core 5 provided with the glue 10 applied beforehand by the application device 11.

In order to allow the transfer of each support core 5 to the joining and coupling station 8, the machine 2 is advantageously equipped with a loading device 18.

In detail, the loading device 18 is operatively interposed between the supply station 4 of the support cores 5 and the joining and coupling station 8.

Again with reference to FIGS. 1 and 2, the loading device 18 comprises a thruster 19 to be set in rotation about a respective rotation axis X transversal to the direction of advancing movement of the support cores 5 and substantially horizontal.

The setting in rotation of the thruster 19 is advantageously actuated by means of a rotating element 20 to which the thruster 19 is fixedly engaged.

The rotation of the rotating element 20 about the aforementioned rotation axis X allows the movement of the thruster 19 from a first position (FIG. 1) in which it is at an end portion of the advancing plane 6 of the supply station 4 of the support cores 5, and a second position (FIG. 2), in which it is at a conveying fitting of the joining and coupling station 8 that extends substantially around a part of the respective roller 17 of the latter.

In detail, when the rotating element 20 is in the first position (FIG. 1), it is ready to push a respective support core 5 to be fed. When the rotating element 20 is in the second position (FIG. 2), it channels a respective support core 5 between the conveying fitting 21 and the roller 17 of the joining and coupling station 8. In this situation, the outer surface of the support core 5 is pressed against the continuous ribbon 15 placed on the roller 17 so that the glue 10 can establish their joining together.

On the opposite side with respect to the supply station 4 of the support cores 5, in particular at an end portion of the conveying fitting 21, the machine 2 provides a winding station 22, at which the continuous ribbon 15 of paper material is wound around a respective support core 5 coming from the joining and coupling station 8.

Advantageously, the winding station 22 comprises at least two winding rollers 23, 24 that collaborate to set in rotation the support core 5 to be wound with the respective continuous ribbon 15 of paper material.

In particular, a winding roller 23 rotatively supports below the respective support core 5 being wound, whereas another winding roller 24, in particular an upper one, ensures its position against the lower winding roller 24 and the roller 17 of the joining and coupling station 8.

Since the winding of the continuous ribbon 15 of paper material around the respective support core 5 causes an increase in overall dimensions of the respective log 3 in formation, the upper winding roller 24 is advantageously supported by a tilting arm 25 hinged at Y (FIGS. 1 and 2).

Once winding is complete, it is necessary to interrupt the continuous ribbon 15 of paper material so that the last sheet of paper can be glued to the log of paper 3 before it is transferred to a subsequent packaging machine.

This interruption is carried out through at least one tearing station 26 of the continuous ribbon 15, which is operatively interposed between the joining and coupling station 8 and the winding station 22.

Advantageously, the tearing station 26 comprises at least one tearing device 1 acting on the part of continuous ribbon 15 placed on the roller 17.

In detail, as can be seen in FIGS. 1 and 2, the tearing device 1 comprises mechanical tearing means 28, operative along the longitudinal development of the continuous ribbon 15, to cause it to tear in correspondence of at least one of the perforation and weakening lines thereof.

The mechanical tearing means 28 are preferably provided with at least one interception portion 29 suitable for engaging, at least temporarily, the continuous ribbon 15 on the roller 17, to cause it to break along a respective perforation and weakening line.

Again with reference to FIGS. 1 and 2, the mechanical tearing means 28 are mobile between a non operative position (FIG. 1), in which the interception portion 29 does not engage the continuous ribbon 15, and an operative position (FIG. 2), in which the interception portion 29 transversally, in particular perpendicularly, engages the engagement surface of the continuous ribbon 15 until it is caused to break along a respective perforation and weakening line. In other words, when the interception portion 29 of the mechanical tearing means 28 is moving to engage the continuous ribbon 15, the interception portion 29 moves from the roller 17 of the joining and coupling station 8 towards the continuous ribbon 15. When the interception portion 29 comes into contact with the continuous ribbon 15, it engages it on the side of the roller 17 to cross it transversally.

Going into greater detail, the mechanical tearing means 28 comprise a plurality of projections 29a that extend substantially parallel to one another. Each projection 29a is advantageously arranged to engage, in operative position (FIG. 2), a respective opening of the respective perforation and weakening line of the continuous ribbon 15.

Preferably, the projections 29a are spaced apart from one another according to a predetermined length, in particular no more than the width of a respective groove 17a of the roller 17 of the joining and coupling station 8 of the machine 2.

The set of projections 29a define a substantially comb-like element the movement of which between the first (FIG. 1) and the second position (FIG. 2) determines the tearing of the continuous ribbon 15 on the grooved roller 17 of the joining and coupling station 8.

In order to receive all of the projections 29a of the mechanical tearing means 28 in its own bulk, the roller 17 of the joining and coupling station 8 has a plurality of grooves 17a substantially parallel to one another and substantially perpendicular to the axis of the roller 17 itself, in other words substantially vertical.

As illustrated in the diagrams represented in FIGS. 1 and 2, each projection 29a extends from a respective appendix 28a of the mechanical tearing means 28. Each appendix 28a advantageously extends substantially in parallel with respect to the other appendices 28a and extends according to at least one substantially arched development.

Advantageously, the depth of each groove 17a of the roller 17 of the joining and coupling station 8 is sufficient to receive most of the structure of the respective appendix 28a, for which reason the latter extends for at least two thirds of its structure within the bulk of the roller 17.

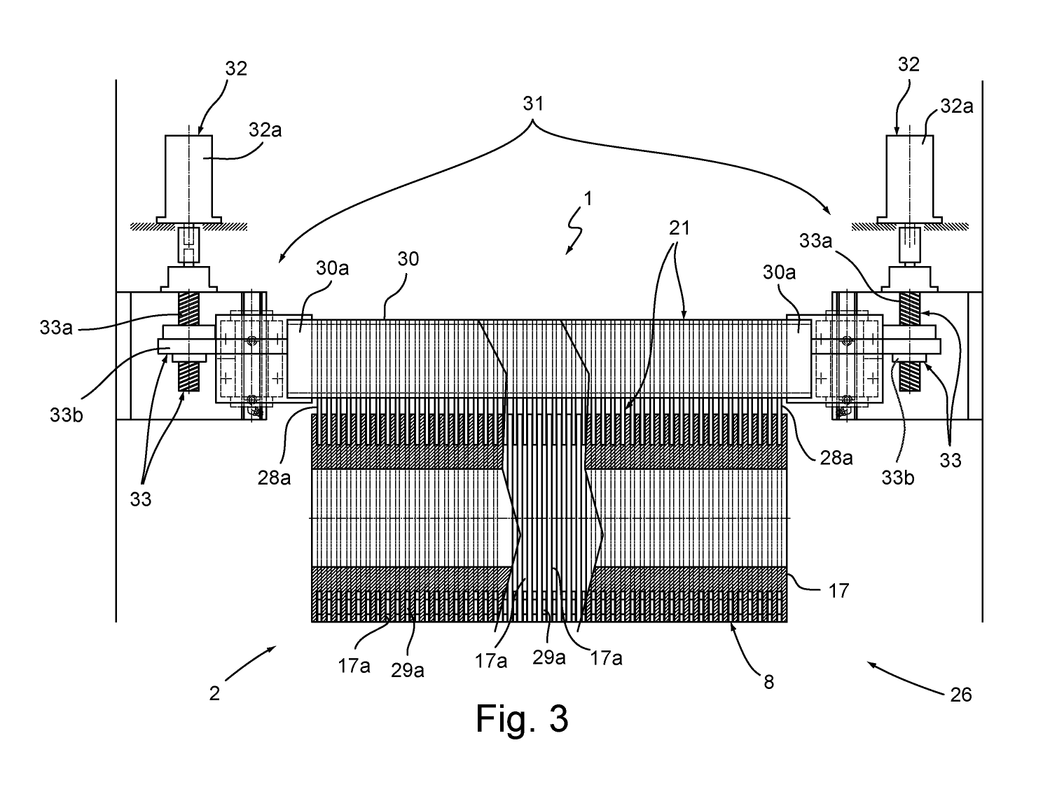

As shown in FIGS. 1 and 2, each appendix 28a is engaged, on the opposite side to the respective projection 29a, with at least one common support bar 30 of the mechanical tearing means 28, which is preferably arranged at least one of the advancing and conveying rollers 16 of the machine 2. The common support bar 30 extends transversally, in particular substantially perpendicularly, to the appendices 28a and is operatively connected to suitable handling means 31 (FIG. 3). The handling means 31 can be actuated between an inactive condition, in which the mechanical tearing means 28 are substantially stationary (FIG. 1), and an active condition, in which the mechanical tearing means 28 are in movement between the non operative position (FIG. 1) and the operative position (FIG. 2).

As can be seen in FIG. 3, the handling means 31 comprise at least one control member 32, in particular a pair of electric motors 32a, and at least one transmission mechanism 33 operatively interposed between the control member 32 and the common support bar 31, in particular a mechanism 33 provided with an endless worm screw 33a with volute 33b operatively interposed between each electric motor 32a and a respective end 30a (FIG. 3) of the common support bar 30.

In accordance with a preferred solution of the present invention, the handling means 31 actuate in translation the mechanical tearing means 28 for which reason the movement of the interception portion 29 corresponds to a translation of the same along a transversal direction, in particular substantially perpendicular, to the continuous ribbon 15 of paper material, flexing the latter until it breaks along the respective transversal perforation and weakening line.

Alternatively, it is not ruled out for the handling means 31 to have a different configuration from the one outlined above and to be able to obtain the same effect of breaking the continuous ribbon 15 of paper material through a rotation of the mechanical tearing means 28, or through a combined movement between rotation and translation.

The object of the present invention solves the problems encountered in the prior art and achieves important advantages.

Firstly, the aforementioned tearing device considerably simplifies the structure of the rewinding machines with which it is associated, obtaining the optimal and precise breaking of the continuous ribbon of paper material along the respective transversal perforation and structural weakening lines.

Moreover, it should be noted that the aforementioned device can easily be made by using components and mechanical members that can easily be found on the market at extremely competitive costs. Therefore, the manufacture and assembly of such devices on a rewinding machine does not require either special studies, or intricate design plans, substantially reducing the costs normally linked to it.

Finally, it should be noted that the structural and functional simplicity of the device described above significantly reduces the maintenance and/or adjustment interventions of the moving members, further contributing to reducing the overall production and commercialisation costs of the logs of paper produced.

1. A tearing device of a continuous ribbon of paper material to be supplied on rewinding machines, said continuous ribbon having a series of transversal spaced perforation and weakening lines according to regular intervals disposed along its own longitudinal development, said device comprising mechanical tearing means to be operatively placed along the longitudinal development of said continuous ribbon, in order to cause the tearing of this latter in correspondence of at least one of said perforation and weakening lines,
wherein said mechanical tearing means comprise at least an interception portion able to engage, at least temporarily, with an engagement surface of said continuous ribbon of paper material resting on a respective roller of a rewinding machine 1, in order to cause its breaking along a respective perforation and weakening line, said mechanical tearing means being movable between a non operative position, in which said interception portion does not engage with said ribbon, and an operative position, in which said interception portion transversally engages, particularly substantially in a perpendicular way, with said engagement surface of said continuous ribbon until causing a breaking along a respective perforation and weakening line.

2. The device according to claim 1, in which said interception portion of said mechanical tearing means comprises a plurality of projections substantially developing in parallel one with the other, said projections being spaced one from the other according to a predetermined length, in particular not higher than the width of a respective groove provided in the respective roller of said rewinding machine.

3. The device according to claim 2, in which each projection extends from a respective appendix of said mechanical tearing means, each appendix developing substantially parallel with respect to the other appendices and developing according to at least one substantially arched development, optionally according at least to a quarter of circumference of said roller of said rewinding machine.

4. The device according to claim 3, in which each appendix is engaged from an opposite portion to said projection to at least a common support bar of said mechanical tearing means, said common support bar developing in a transversal way, in particular substantially perpendicular to said appendices and being operatively connected to handling means to be actuated between an inactive condition, in which said mechanical tearing means are substantially stationary, and an active condition, in which said mechanical tearing means are handled between a non operative position and the operative position.

5. The device according to claim 4, in which said handling means comprise:
at least a control member, in particular a pair of electric motors; and
at least a transmission mechanism operatively interposed between said control member and said common support bar, in particular a mechanism provided with an endless worm screw with a volute operatively interposed between each electrical motor and a respective end of said common support bar, said handling means actuating in translation said mechanical tearing means, so that the handling of said interception portion of these latter corresponds to a translation of said interception portion along a transversal direction, in particular substantially perpendicular, to said continuous ribbon of paper material.

6. A rewinding machine for the formation of logs of paper, comprising:
at least a supply station of support cores, of a substantially cylindrical form;
at least an application station of a glue, placed at said supply station of said support cores in order to apply on these latter at least a predefined quantity of glue;
at least a supply station of a continuous ribbon of paper material having a plurality of transversal perforation and weakening lines spaced according to regular intervals along the longitudinal development of said continuous ribbon;
at least a joining station of said support cores to said continuous ribbon of paper material;
at least a winding station of said continuous ribbon of paper material around said support cores coming from said joining station; and
at least a tearing station of said continuous ribbon of paper material interposed between said joining stations and winding stations,
wherein said tearing station of said continuous ribbon of paper material comprises a tearing device according to claim 1.

7. A tearing method of a continuous ribbon of paper material on rewinding machines, comprising the steps of:
supplying a continuous ribbon of paper material to an joining station, said continuous ribbon having a plurality of transversal perforation and weakening lines spaced according to regular intervals along its own longitudinal development;
supplying at least a support core to said joining station; and
winding said continuous ribbon around a respective support core, mechanically tearing said continuous ribbon of paper material in correspondence of at least one of said transversal perforation lines,
wherein tearing step comprises the following steps:
transversally intercepting an engagement surface of said continuous ribbon of paper material resting on a roller of a rewinding machine, in correspondence of at least one of said perforation and weakening lines, and
applying a force, of a predetermined intensity, substantially normal to said continuous ribbon in the interception point of the same, in order to determine its breaking along a respective transversal perforation and weakening line.
